(19) United States
(12) Patent Application Publication
(10) Pub. No.: US 2006/0243024 A1
(43) Pub. Date: Nov. 2, 2006

(54) Gas identity analysis by differential mass

(76) Inventor: Thomas Badstubner, Blackstone, MA (US)

Correspondence Address: Mr. Thomas L. Badstubner, 7 Handy Rd, Blackstone, MA, 01504, US

(21) Appl. No.: 11/114,919

(22) Filed: Apr. 27, 2005

(51) Int. Cl. G01N 7/00

(52) U.S. Cl. 73/23.2

(57) ABSTRACT

A scale and container of known volume are used to determine the differential mass of an unknown gas compared to air. The differential mass of the unknown gas is compared to known differential masses of possible gases and the identity of the unknown gas is determined.

### CROSS-REFERENCE TO RELATED APPLICATIONS

Not Applicable

### STATEMENT REGARDING FEDERALLY SPONSORED RESEARCH OR DEVELOPMENT

not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates to a method for determining the identity of an unknown gas, by first identifying the density of the gas. Gases are usually identified by means of chromatography which is both costly and time consuming.

### BRIEF SUMMARY OF THE INVENTION

It is the object of the invention to determine the identity of an unknown gas (typically nitrogen). The density of the unknown gas is determined by weighing a known volume and comparing it to the established weight of known gases at that volume. This method is preferable to existing methods because it reduces the expense of the alternative apparatus and training.

### BRIEF DESCRIPTION OF THE SEVERAL VIEWS OF THE DRAWINGS

Not Applicable

### DETAILED DESCRIPTIONS OF THE INVENTION

The weight of the unknown gas is determined by first weighing an open mouthed container of known volume filled with air at atmospheric pressure and ambient temperature. The scale is then set at zero. Then the unknown gas is flowed into the container displacing the air. The container weight is then taken to determine the differential mass of the unknown gas in the container. The differential mass is compared to Table 1, and the gas is preliminarily identified. Certain possible gases are excluded from consideration by their chemical properties. For example, in the case of nitrogen:
Carbon monoxide is excluded because a specific chemical test can be performed to determine the carbon monoxide concentration if carbon monoxide is suspected of being present.
Any odorous gases (ethylene, etc.) are excluded because an odor test (organoleptic) can be performed if those gases are suspected of being present.

All other gases have densities which are significantly different from nitrogen.

TABLE 1
Differential Mass of Known Gases

| | | | | N2 | N2 |
|---|---|---|---|---|---|
| | Molecular | | | Delta | Delta |
| Gas | Weight | g/liter | g/2 liter | 2 L | 1 L |
| Hydrogen | 2.0159 | 0.089 | 0.178 | −2.301 | −1.150 |
| Helium | 4.0026 | 0.177 | 0.354 | −2.125 | −1.062 |
| Deuterium | 4.032 | 0.178 | 0.357 | −2.122 | −1.061 |
| Methane | 16.043 | 0.710 | 1.420 | −1.059 | −0.530 |
| Anhydrous Ammonia | 17.031 | 0.754 | 1.507 | −0.972 | −0.486 |
| Water | 18.02 | 0.797 | 1.595 | −0.884 | −0.442 |
| Neon | 20.183 | 0.893 | 1.786 | −0.693 | −0.346 |
| Acetylene | 26.038 | 1.152 | 2.304 | −0.175 | −0.087 |
| Hydrogen Cyanide | 27.03 | 1.196 | 2.392 | −0.087 | −0.043 |
| Carbon Monoxide | 28.0104 | 1.239 | 2.479 | 0.000 | 0.000 |
| Nitrogen | 28.0134 | 1.240 | 2.479 | 0.000 | 0.000 |
| Ethylene | 28.054 | 1.241 | 2.483 | 0.004 | 0.002 |
| Air | 28.96 | 1.281 | 2.563 | 0.084 | 0.042 |
| Nitric Oxide | 30.06 | 1.330 | 2.660 | 0.181 | 0.091 |
| Ethane | 30.07 | 1.331 | 2.661 | 0.182 | 0.091 |
| Monomethylamine | 31.058 | 1.374 | 2.748 | 0.269 | 0.135 |
| Oxygen | 32 | 1.416 | 2.832 | 0.353 | 0.176 |
| Methanol | 32.042 | 1.418 | 2.836 | 0.357 | 0.178 |
| Silane | 32.112 | 1.421 | 2.842 | 0.363 | 0.181 |
| Phosphine | 34 | 1.504 | 3.009 | 0.530 | 0.265 |
| Hydrogen Sulfide | 34.08 | 1.508 | 3.016 | 0.537 | 0.268 |
| Hydrogen Chloride | 36.461 | 1.613 | 3.227 | 0.748 | 0.374 |
| Argon | 39.948 | 1.768 | 3.535 | 1.056 | 0.528 |
| Argon, UHP | 39.948 | 1.768 | 3.535 | 1.056 | 0.528 |
| Allene (Propadiene) | 40.065 | 1.773 | 3.546 | 1.067 | 0.533 |
| Methyl Acetylene | 40.07 | 1.773 | 3.546 | 1.067 | 0.534 |
| Propylene | 42.079 | 1.862 | 3.724 | 1.245 | 0.622 |
| Cyclopropane | 42.08 | 1.862 | 3.724 | 1.245 | 0.622 |
| Nitrous Oxide | 44.01 | 1.947 | 3.895 | 1.416 | 0.708 |
| Carbon Dioxide | 44.011 | 1.947 | 3.895 | 1.416 | 0.708 |
| Ethylene Oxide | 44.053 | 1.949 | 3.898 | 1.419 | 0.710 |
| Propane | 44.11 | 1.952 | 3.904 | 1.425 | 0.712 |
| Dimethylamine | 45.085 | 1.995 | 3.990 | 1.511 | 0.755 |
| Monoethylamine | 45.085 | 1.995 | 3.990 | 1.511 | 0.755 |
| Nitrogen Dioxide | 46.01 | 2.036 | 4.072 | 1.593 | 0.796 |
| Dimethylether | 46.069 | 2.038 | 4.077 | 1.598 | 0.799 |
| Ethanol | 46.07 | 2.038 | 4.077 | 1.598 | 0.799 |
| Methyl Chloride | 50.49 | 2.234 | 4.468 | 1.989 | 0.995 |
| Cyanogen | 52.036 | 2.302 | 4.605 | 2.126 | 1.063 |
| 1,3-Butadiene | 54.092 | 2.393 | 4.787 | 2.308 | 1.154 |
| 1-Butene | 56.108 | 2.483 | 4.965 | 2.486 | 1.243 |
| cis-2-Butene | 56.108 | 2.483 | 4.965 | 2.486 | 1.243 |
| Isobutylene | 56.11 | 2.483 | 4.965 | 2.486 | 1.243 |
| Trans-2-Butene | 56.12 | 2.483 | 4.966 | 2.487 | 1.244 |
| Acetone | 58.08 | 2.570 | 5.140 | 2.661 | 1.330 |
| Butane | 58.124 | 2.572 | 5.144 | 2.665 | 1.332 |
| Isobutane | 58.124 | 2.572 | 5.144 | 2.665 | 1.332 |
| Trimethylamine | 59.11 | 2.615 | 5.231 | 2.752 | 1.376 |
| Carbonyl Sulfide | 60.07 | 2.658 | 5.316 | 2.837 | 1.418 |
| Vinyl Chloride | 62.5 | 2.765 | 5.531 | 3.052 | 1.526 |
| Sulfur Dioxide | 64.063 | 2.835 | 5.669 | 3.190 | 1.595 |
| Ethyl Chloride | 64.52 | 2.855 | 5.710 | 3.231 | 1.615 |
| Carbonyl Fluoride | 66.007 | 2.921 | 5.841 | 3.362 | 1.681 |
| Boron Trifluoride | 67.805 | 3.000 | 6.000 | 3.521 | 1.761 |
| Isoprene | 68.119 | 3.014 | 6.028 | 3.549 | 1.775 |
| Cyclopentane | 70.135 | 3.103 | 6.207 | 3.728 | 1.864 |
| 1-Pentene | 70.135 | 3.103 | 6.207 | 3.728 | 1.864 |
| Chlorine | 70.906 | 3.137 | 6.275 | 3.796 | 1.898 |
| 2,2 Dimethylpropane | 72.151 | 3.193 | 6.385 | 3.906 | 1.953 |
| (Neopentane) | | | | | |
| n-Pentane | 72.151 | 3.193 | 6.385 | 3.906 | 1.953 |
| iso-Pentane | 72.151 | 3.193 | 6.385 | 3.906 | 1.953 |
| Arsine | 77.946 | 3.449 | 6.898 | 4.419 | 2.209 |
| Benzene | 78.114 | 3.456 | 6.913 | 4.434 | 2.217 |
| Hydrogen Bromide | 80.912 | 3.580 | 7.160 | 4.681 | 2.341 |
| Hydrogen Selenide | 80.976 | 3.583 | 7.166 | 4.687 | 2.344 |
| Krypton | 83.8 | 3.708 | 7.416 | 4.937 | 2.468 |
| 1-Hexene | 84.16 | 3.724 | 7.448 | 4.969 | 2.484 |
| Methylcyclopentane | 84.162 | 3.724 | 7.448 | 4.969 | 2.484 |
| Cyclohexane | 84.162 | 3.724 | 7.448 | 4.969 | 2.484 |
| Hexane | 86.178 | 3.813 | 7.626 | 5.147 | 2.574 |
| 2,3-Dimethylbutane | 86.178 | 3.813 | 7.626 | 5.147 | 2.574 |
| 2-Methylpentane | 86.178 | 3.813 | 7.626 | 5.147 | 2.574 |
| 3-Methylpentane | 86.178 | 3.813 | 7.626 | 5.147 | 2.574 |
| Neohexane | 86.178 | 3.813 | 7.626 | 5.147 | 2.574 |
| Chlorodifluoromethane | 86.5 | 3.827 | 7.655 | 5.176 | 2.588 |
| (R-22) | | | | | |
| Tetrafluoromethane | 88.01 | 3.894 | 7.788 | 5.309 | 2.655 |
| Toluene | 92.141 | 4.077 | 8.154 | 5.675 | 2.838 |
| Methylcyclohexane | 98.189 | 4.345 | 8.689 | 6.210 | 3.105 |
| Phosgene | 98.92 | 4.377 | 8.754 | 6.275 | 3.137 |
| n-Heptane | 100.205 | 4.434 | 8.868 | 6.389 | 3.194 |
| 2-Methylhexane | 100.205 | 4.434 | 8.868 | 6.389 | 3.194 |
| 3-Methylhexane | 100.205 | 4.434 | 8.868 | 6.389 | 3.194 |
| 3-Ethylpentane | 100.205 | 4.434 | 8.868 | 6.389 | 3.194 |
| 2,2-Dimethylpentane | 100.205 | 4.434 | 8.868 | 6.389 | 3.194 |
| 2,4-Dimethylpentane | 100.205 | 4.434 | 8.868 | 6.389 | 3.194 |
| 3,3-Dimethylpentane | 100.205 | 4.434 | 8.868 | 6.389 | 3.194 |
| Dichlorosilane | 101.01 | 4.469 | 8.939 | 6.460 | 3.230 |
| Silicon Tetrafluoride | 104.08 | 4.605 | 9.211 | 6.732 | 3.366 |
| Styrene | 104.152 | 4.608 | 9.217 | 6.738 | 3.369 |
| o-Xylene | 106.168 | 4.698 | 9.395 | 6.916 | 3.458 |
| p-Xylene | 106.168 | 4.698 | 9.395 | 6.916 | 3.458 |
| Ethylbenzene | 106.168 | 4.698 | 9.395 | 6.916 | 3.458 |
| m-Xylene | 106.17 | 4.698 | 9.396 | 6.917 | 3.458 |
| Octane | 114.232 | 5.055 | 10.109 | 7.630 | 3.815 |
| Isooctane | 114.232 | 5.055 | 10.109 | 7.630 | 3.815 |
| Boron Trichloride | 117.17 | 5.185 | 10.369 | 7.890 | 3.945 |
| Isopropylbenzene | 120.195 | 5.318 | 10.637 | 8.158 | 4.079 |
| n-Nonane | 128.256 | 5.675 | 11.350 | 8.871 | 4.436 |
| Xenon | 131.3 | 5.810 | 11.619 | 9.140 | 4.570 |
| n-Decane | 142.286 | 6.296 | 12.592 | 10.113 | 5.056 |
| Sulfur Hexafluoride | 146.054 | 6.463 | 12.925 | 10.446 | 5.223 |

What is claimed is:

1. A method for identifying a gas by means of first determining the differential mass of a known volume of the unknown gas and comparing the result to the established differential mass of known gases.

2. A method as in claim 1 wherein the weight of the fixed volume container is nulled by filling with air at atmospheric pressure and ambient temperature, observing the indicated weight and taring the scale indication to zero.

3. A method as in claim 1 wherein an unknown gas is flowed into an empty container displacing the air.

4. A method as in claim 1 wherein the container weight is then taken to determine the differential mass of the unknown gas in the container compared to the weight of the container filled with air at atmospheric pressure and ambient temperature.

5. A method as in claim 1 wherein the differential mass of the unknown gas is compared known differential masses of possible gases.

6. A method as in claim 1 wherein the certain possible gases are excluded from consideration by their chemical properties and the identity of the unknown gas is concluded.
